(19) United States
(12) Patent Application Publication
(10) Pub. No.: US 2002/0072977 A1
(43) Pub. Date: Jun. 13, 2002

(54) Analyzing inventory using time frames

(76) Inventors: Robert S. Hoblit, Knightdale, NC (US); Charles R. Messina, Knightdale, NC (US)

Correspondence Address: IBM CORPORATION, PO BOX 12195, DEPT 9CCA, BLDG 002, RESEARCH TRIANGLE PARK, NC, 27709, US

(21) Appl. No.: 09/732,346

(22) Filed: Dec. 7, 2000

(51) Int. Cl. G06F 17/60; G06G 1/14

(52) U.S. Cl. 705/22; 705/28

(57) ABSTRACT

A method, computer program product and system for analyzing inventory information using time frames. In one embodiment, a method comprises the step of determining estimated sales projections for one or more items in a particular time frame. The method further comprises collecting sales data for the one or more items in the particular frame. By analyzing estimated sales projections with the sales data collected for the one or more items in the particular time frame, item(s) that have performed unexpectedly may be identified. The method further comprises notifying an interested party or a system regarding any items of the one or more items in the particular time frame that have performed unexpectedly.

### TECHNICAL FIELD

The present invention relates to the field of inventory management systems, and more particularly to a program that analyzes inventory information using time frames.

### BACKGROUND INFORMATION

A reliable inventory management system is important for any business involved with the sale of goods or services. In order to manage inventory resources properly, businesses must maintain a sufficient amount of inventory on stock, accurately keep track of inventory count, as well as timely re-stock an appropriate amount of inventory. It is extremely difficult to maintain just enough inventory on stock that sustains a sufficient amount of stock to satisfactorily fulfill customers' orders without over-stocking. A delicate balance is necessary to avoid over-stocking, which poses many risks such as tying up funds and incurring maintenance costs, including storage space expense, spoilage and damage, and depreciation of inventory value.

There is a wide array of inventory management strategies available, for example, make-to-order, Kanban, and fixed-rate supply. A detailed description of the Kanban method is provided in Monden & Yasuhiro, Toyota Production System (2d ed. 1993). These inventory management strategies implement different re-order points and replenishment quantity. For example, under the make-to-order strategy, there is no stock in a warehouse and products are manufactured whenever a customer places an order. On the other hand, under the Kanban strategy, a small stock is maintained in the warehouse and inventory is replenished as it is depleted.

Other inventory management systems involve forecasting or predicting the demand of customers and formulating a sales plan thereby attempting to supply the proper amount of stock. In a conventional system for forecasting the product demand and determining the sales plan, the sales plan may be determined on the basis of sales results, including the sales demand of individual products, component ratio of the sales, and profit rate, as well as on the basis of an index showing ease of sales promotion of individual products. Based on the sales plan developed, an optimal inventory level may be determined.

Unfortunately, these inventory management systems do not detect stock levels of particular item(s) within particular time frames, e.g., 3 pm-5 pm, within the retail store itself and provide a notification to an appropriate party or system regarding item(s) that have performed unexpectedly, i.e., selling appreciably more or less than expected.

It would therefore be desirable to develop a program that analyzes inventory information within particular time frames and provides a notification to an appropriate party or system regarding item(s) that have performed unexpectedly.

### SUMMARY

The problems outlined above may at least in part be solved in some embodiments by estimating sales projections and collecting sales data for one or more items in a particular time frame. A particular time frame may refer to a window or a snapshot in time. For example, a time frame may be from 12:00 pm-3:30 pm on a particular day. By analyzing estimated sales projections with the sales data collected for the one or more items in the particular time frame, item(s) that have performed unexpectedly, e.g., sold an appreciable amount greater or less than estimated, may be identified and reported to an interested party or system shortly after the end of the particular time frame. The interested party may then take appropriate action to solve the problem as to why the item(s) were performing unexpectedly. By identifying and reporting item(s) that have performed unexpectedly shortly after the end of the particular time frame instead of at the end of the week or day, problems as to why item(s) were performing unexpectedly may be solved more quickly and thereby save the retailer from the cost of forgone revenue, lost potential for additional business, reduced profit margins, etc.

In one embodiment, a method for analyzing inventory information using time frames comprises the step of determining estimated sales projections for one or more items in a particular time frame. The method further comprises collecting sales data for the one or more items in the particular time frame. The sales data may be collected in a substantially real-time manner or in a batch manner. The sales data collected for the one or more items in the particular time frame and the estimated sales projections for the one or more items in the particular time frame may be analyzed for determining whether any of the one or more items in the particular time frame performed unexpectedly. The method further comprises notifying an interested party or a system regarding any items of the one or more items in the particular time frame that have performed unexpectedly.

In another embodiment of the present invention, the method further comprises generating a report regarding any items of the one or more items in the particular time frame that have performed unexpectedly.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates an embodiment of a POS terminal configured in accordance with the present invention;

FIG. 2 illustrates a data processing system configured in accordance with the present invention; and

FIG. 3 is a flowchart of a method for analyzing inventory information within particular time frames.

### DETAILED DESCRIPTION

The present invention comprises a method, computer program product and system for analyzing inventory information using time frames. In one embodiment of the present invention, estimated sales projections for one or more items may be determined for a particular time frame. Sales data may then be collected for the one or more items in the particular time frame. The sales data may be collected in a substantially real-time manner or in a batch manner. By analyzing estimated sales projections with the sales data collected for the one or more items in the particular time frame, item(s) that have performed unexpectedly, e.g., sold an appreciable amount greater or less than estimated, may be identified. An interested party or system may then be notified shortly after the end of the particular time frame regarding any items of the one or more items in the particular time frame that have performed unexpectedly. In another embodiment of the present invention, a report may be generated regarding any items of the one or more items in the particular time frame that have performed unexpectedly.

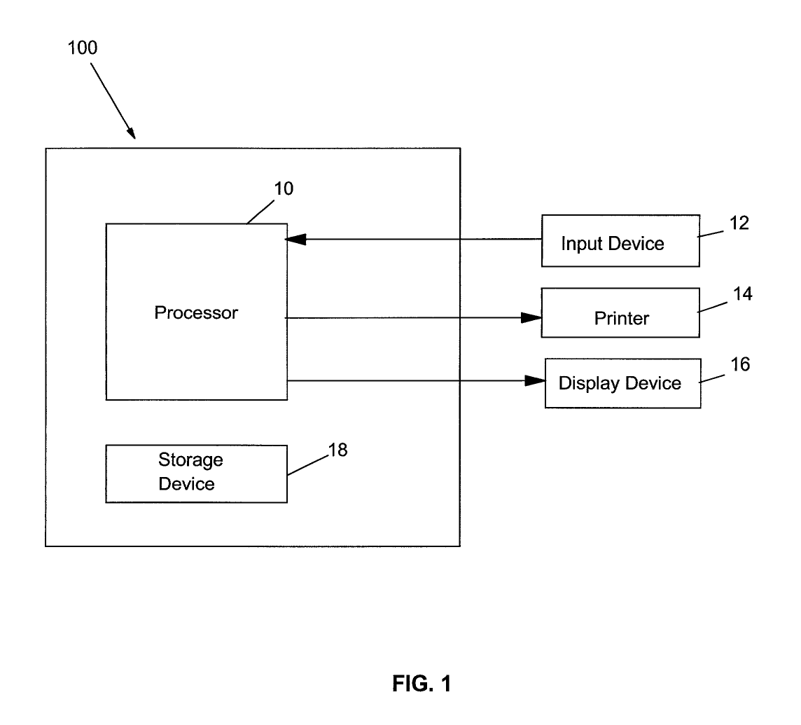

FIG. 1—POS Terminal

FIG. 1 illustrates an embodiment of the present invention of a point-of-sale (POS) terminal 100. Most retail stores that are visited by customers have one or more POS terminals 100, such as cash registers. Store cashiers use POS terminals 100 for calculating the total price of a purchase and the amount of change due to a customer. POS terminals 100 may further be configured for keeping track of purchases made and adjust a database of store inventory accordingly.

Referring to FIG. 1, POS terminal 100 comprises a processor 10 coupled to an input device 12, a printer 14 and a display device 16. Processor 10 may be coupled to a storage device 18, e.g., RAM, floppy disk, hard disk.

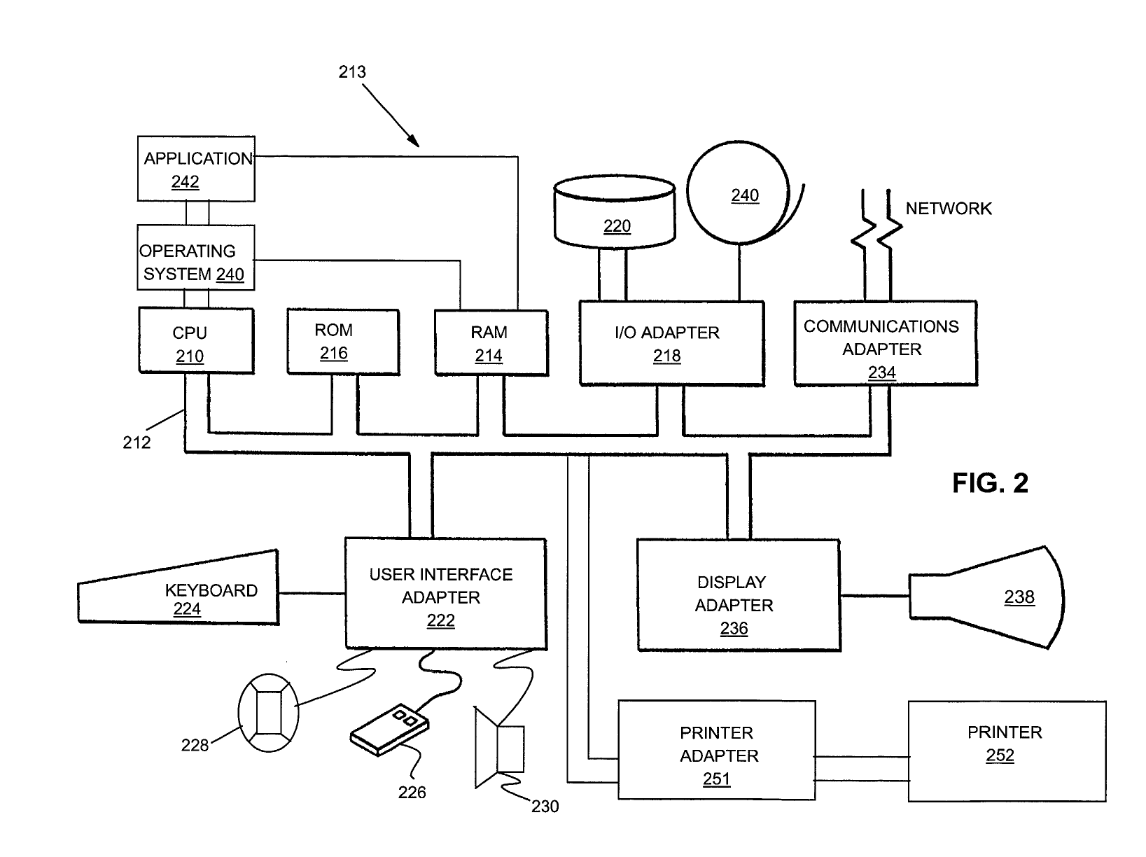

Processor 10 and storage device 18 may each be (i) located entirely within a cash register; (ii) connected thereto by a remote communication link, such as a serial port cable, telephone line or radio frequency transceiver; or (iii) a combination thereof. For example, processor 10 may comprise one or more cash registers connected to a remote computer as illustrated in FIG. 2. It is noted that many types of conventional cash registers and other types of POS terminals may be used to implement the present invention in light of the present disclosure.

Referring to FIG. 1, input device 12 may be a keypad for inputting signals indicative of a purchase to processor 10. Printer 14 may be used for printing receipts, coupons and vouchers as directed by processor 10. Display device 16 may be used for displaying alphanumeric characters, e.g., listing of the items purchased along with the purchase price of each item, to the cashier and/or customer. It is noted that there are numerous types of input devices, printers and display devices known to those skilled in the art and thus need not be described in detail herein.

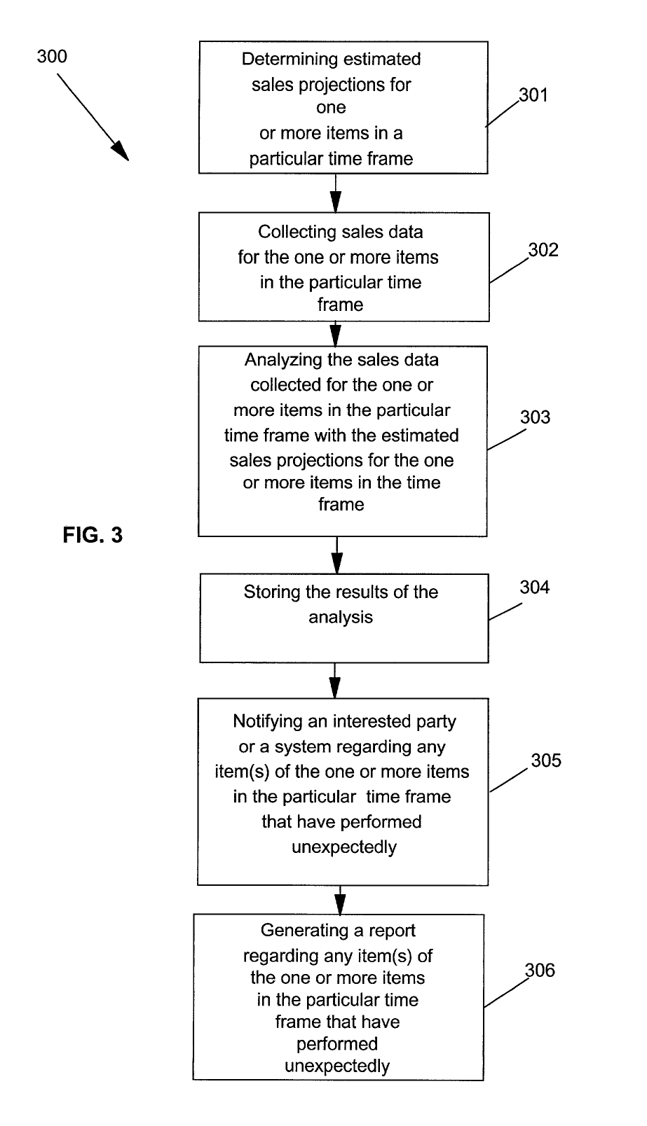

Storage device 18 may comprise an inventory price database which includes a listing of products and the corresponding product prices. The inventory price database allows processor 10 to calculate a total purchase price of one or more products. Storage device 18 may further comprise an on-line inventory database which keeps a current count of the quantity of each product left to be purchased by customers. It is noted that the on-line inventory database may not be accurate due to theft, damaged goods, etc. In one embodiment, storage device 18 may comprise a program of the present invention that analyzes inventory information within particular time frames and provides a notification to an appropriate party or system regarding item(s) that have performed unexpectedly as further described in FIG. 3.

FIG. 2—Computer System

FIG. 2 illustrates a typical hardware configuration of data processing system 213 which is representative of a hardware environment for practicing the present invention. As stated above, one or more POS terminals 100 may be connected to data processing system 213. Data processing system 213 has a central processing unit (CPU) 210, such as a conventional microprocessor, coupled to various other components by system bus 212. An operating system 240, e.g., DOS, OS/2™, runs on CPU 210 and provides control and coordinates the function of the various components of FIG. 2. An application 242 runs in conjunction with operating system 240 and provides output calls to operating system 240 which implements the various functions to be performed by the application 242. Read only memory (ROM) 216 is coupled to system bus 212 and includes a basic input/output system (“BIOS”) that controls certain basic functions of data processing system 213. Random access memory (RAM) 214, I/O adapter 218, and communications adapter 234 are also coupled to system bus 212. It should be noted that software components including operating system 240 and application 242 are loaded into RAM 214 which is the computer system's main memory. I/O adapter 218 may be a small computer system interface (“SCSI”) adapter that communicates with disk units 220, e.g., disk drive, and tape drives 240. In one embodiment, the program of the present invention that analyzes inventory information within particular time frames may reside in disk unit 220 or in application 242. Communications adapter 234 interconnects bus 212 with an outside network enabling data processing system 213 to communication with other such systems, e.g., one or more POS terminals 100. Input/Output devices are also connected to system bus 212 via a user interface adapter 222, a display adapter 236 and a printer adapter 251. Keyboard 224, trackball 228, mouse 226 and speaker 230 are all interconnected to bus 212 through user interface adapter 222. A display monitor 238 is connected to system bus 212 by display adapter 236. A printer 252 is connected to system bus 212 by printer adapter 251. In this manner, a user is capable of inputting to system 213 through keyboard 224, trackball 228 or mouse 226 and receiving output from system 213 via display 238, speaker 230 or printer 252.

Preferred implementations of the invention include implementations as a computer system programmed to execute the method or methods described herein, and as a computer program product. According to the computer system implementations, sets of instructions for executing the method or methods are resident in the random access memory 214 of one or more computer systems configured generally as described above. Until required by the computer system, the set of instructions may be stored as a computer program product in another computer memory, for example, in disk drive 220 (which may include a removable memory such as an optical disk or floppy disk for eventual use in disk drive 220). Furthermore, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 3—Method For Analyzing Inventory Information

FIG. 3 illustrates a method 300 according to an embodiment of the present invention. FIG. 3 is a method 300 for analyzing inventory information within particular time frames and providing a notification to an appropriate party or system regarding item(s) that have performed unexpectedly.

In step 301, estimated sales projections for one or more items in a particular time frame may be determined. A time frame may be generated for one or more items. A time frame may refer to a window or a snapshot in time. For example, a time frame may be from 3:00 pm-5:00 pm. Another time frame maybe from 12:00 am-6:00 am. For that particular time frame, an estimated number of sales for a particular item(s) may be calculated. For example, it may be estimated that six item A's will be sold from 3:00 pm-5:00 pm and twelve item B's will be sold from 12:00 am-6:00 am on this particular day. The estimated number of sales for a particular time frame may be derived from sales trends and sales projection data over a time duration that exceeds the particular time frame. For example, a retailer may have inventory information that indicates that the retailer generates 10% of its revenues on Monday with a sales trend of selling 30% of its merchandise that it sells on Monday from 3:00-5:00 pm and 10% of its merchandise that it sells on Monday from 12:00 am-6:00 am. The retailer may further have inventory information that indicates that it sells 200 item A's and 1200 item B's for a typical week. If we are interested in determining an estimated sales projection of item A for the time frame of 3:00 pm-5:00 pm on Monday and an estimated sales projection of item B for the time frame of 12:00 am-6:00 am on Monday, then the estimated sales projection of items A and B may be determined by multiplying the expected number of sales for a week with the percentage of revenues generated for Monday and the percentage of merchandise sold during the respective time frame. Hence, the estimated sales projection of item A during the time frame of 3:00 pm-5:00 pm on Monday would be 200*.1*.3 which yields 6. Thus, the retailer may expect to sell six item A's during the time frame of 3:00 pm-5:00 pm on Monday. The estimated sales projection of item B during the time frame of 12:00 am-6:00 am on Monday would be 1200*.1*.1 which yields 12. Thus, the retailer may expect to sell twelve item B's during the time frame of 12:00 am-6:00 am on Monday. It is noted that the above example illustrates that time frames may be independent across items. That is, each particular time frame may vary per item(s) and not just vary by time. It is further noted that there are numerous methods of determining an estimated sales projection for one or more items in a particular time frame and that the above method is used for illustration purposes only.

As stated above, time frames may be generated for one or more particular items. It is noted that the duration of time of the time frames may be any amount of time. It is further noted that the size of the time frames may be adjustable so that a user of POS terminal 100 or data processing system 213 may adjust the time frame to view a different estimated sales projection for the one or more items. For example, an initial time frame may be set for a particular duration of time. Upon estimating the sales projections for one or more items in the particular time frame, a determination may be made as to whether the particular time frame may need to be adjusted, e.g., expanded. If the expected sales projections for any of the one or more items in the particular time frame do not exceed a minium criteria or the amount of the sales projections is not statistically relevant, then the time frame for any of those one or more items may be adjusted, e.g., expanded, so as to determine estimated sales projections that exceed a minimum criteria or are statistically relevant. It is noted that the time frames may be adjusted any number of times. It is further noted that the time frames may be adjusted, e.g., expanded, by any amount of time.

In step 302, sales data for the one or more items in the particular time frame may be collected. For example, the units sold for each of the one or more items of interest during the particular time frame may be collected. In one embodiment, the sales data may be collected by storage device 18 in one or more POS terminals 100. Storage device 18 may comprise an on-line inventory database which keeps track of the current count of the one or more items associated with the particular time frame that are left in the store to be purchased by customers. Storage device 18 may further keep track of the number of sales, i.e., units sold, of the one or more items within the particular time frame. In another embodiment, the sales data collected by storage device 18 in one or more POS terminals 100 may be transmitted to data processing system 213. For example, storage device 18 may store the number of sales for the one or more items during the particular time frame, e.g., 3:00 pm-5:00 pm on Monday, and then transmit that inventory information to data processing system 213. In one embodiment, the sales data may be collected and transmitted in a substantially real-time manner. In another embodiment, the sales data may be collected and transmitted in a batch manner. It is noted that the data transmitted to data processing system 213 may not be in chronological order. For example, one of the one or more POS terminals 100 may be off-line during the particular time frame and once on-line transmit sales data for the particular time frame after the particular time frame period ended.

In step 303, an analysis is performed using the sales data collected for the one or more items in the particular time frame in step 302 and the estimated sales projections for the one or more items in the particular time frame determined in step 301. The results of the analysis may be used by the retailer to determine whether one or more of the items in the time frame performed unexpectedly as will be further described instep 305. In one embodiment, an absolute comparison analysis may be performed. For example, if the sales data collected indicated that twelve item A's were sold during the time frame of 3:00 pm-5:00 pm on Monday and the expected sales projection of item A during that same time frame was six, an absolute comparison would indicate that six more units of item A sold than expected. If the sales data collected indicated that two item B's were sold during the time frame of 12:00 am-6:00 am on Monday and the expected sales projection of item B during that same time frame were twelve, an absolute comparison would indicate that ten fewer units of item B sold than expected. In another embodiment, a statistical analysis may be performed using the sales data collected for the one or more items in the particular time frame in step 302 and the estimated sales projections for the one or more items in the particular time frame determined in step 301. For example, a statistical analysis of the difference between the sales data collected for the one or more items in the particular time frame in step 302 and the estimated sales projections for the one or more items in the particular time frame determined in step 301 may be performed using a statistical analysis tool, e.g., Poisson distribution.

In step 304, the results of the analysis in step 303 are stored. In one embodiment, the results of the comparison may be stored in memory, e.g., RAM 214, ROM 216, disk unit 220, of data processing system 213. In another embodiment, the results of the comparison may be stored in storage device 18.

In step 305, an interested party, e.g., manager, division, or a system, e.g., headquarter's host system, division host system, e-mail system, database, may be notified regarding any item(s) of the one or more items in the particular time frame that have performed unexpectedly. Item(s) that have performed unexpectedly may refer to those item(s) that have sold an appreciable amount greater than estimated or an appreciable amount less than estimated. It is noted that the threshold for whether or not an item has performed unexpectedly may be determined by the retailer. It is further noted that the interested party or system may be notified shortly after the end of the particular time frame. In one embodiment, the interested party may be notified via electronic mail. In another embodiment, the interested party may be notified via paging. In another embodiment, the interested party may be notified via a report as will be described below. It is further noted that the notification may be performed in a substantially real-time manner upon a determination that any item(s) of the one or more items in the particular time frame have performed unexpectedly. Once the interested party or system has been notified regarding any item(s) of the one or more items in the particular time frame that have performed unexpectedly, the interested party may take appropriate action to solve the problem of why the item(s) were performing unexpectedly. For example, item(s) may be selling an appreciable amount less than estimated during the time frame because the item(s) were not displayed at a location the customers expected to find the item(s). Hence, the interested party may move the item(s) to an appropriate location. Another example as to why the item(s) may be selling an appreciable amount less than estimated during the time frame may be because the item(s) were not located on the sales floor available to customers but were present in the warehouse area of the store. Hence, the interested party may move the item(s) from the warehouse area to the sales floor. Another example as to why the item(s) may be selling an appreciable amount less than estimated during the time frame may be because the displays are poorly set-up and the item(s) on the displays are difficult for the customers to select for purchase. Hence, the interested party may adjust the displays so that the item(s) are easier for the customers to select for purchase. If the item(s) were selling an appreciable amount greater than estimated during the time frame, the interested party upon notification may re-stock the shelves of item(s) that have sold an appreciable amount greater than estimated.

In step 306, a report regarding any item(s) of the one or more items in the particular time frame that have performed unexpectedly may be generated. In one embodiment, the report may comprise a list of the item(s) that have performed unexpectedly. In another embodiment, the report may comprise a list of time frames along with any item(s) that have performed unexpectedly within each of those respective time frames. It is noted that the reports may comprise other information that may be used to identify item(s) that have performed unexpectedly.

It is noted that the program of the present invention that executes the method or methods described above may reside in disk unit 20 or application 42 of data processing system 213. It is further noted that the program of the present invention that executes the method or methods described above may reside in storage device 18 of one or more POS terminals 100.

Although the method, computer program product and system of the present invention are described in connection with several embodiments, it is not intended to be limited to the specific forms set forth herein, but on the contrary, it is intended to cover such alternatives, modifications, and equivalents, as can be reasonably included within the spirit and scope of the invention as defined by the appended claims. It is noted that the headings are used only for organizational purposes and not meant to limit the scope of the description or claims.

1. A method for analyzing inventory information using time frames comprising the steps of:
determining estimated sales projections for one or more items in a particular time frame;
collecting sales data for said one or more items in said particular time frame;
analyzing sales data collected for said one or more items in said particular time frame with said estimated sales projections for said one or more items in said particular time frame; and
notifying an interested party or a system regarding any items of said one or more items in said particular time frame that have performed unexpectedly versus said estimated sales projections.

2. The method as recited in claim 1 further comprising the step of:
storing results of said analysis of said sales data collected for said one or more items in said particular time frame with said estimated sales projections for said one or more items in said particular time frame.

3. The method as recited in claim 1, wherein said estimated sales projections in said particular time frame are derived from sales trends and sales projection data over a time duration that exceeds said particular time frame.

4. The method as recited in claim 1, wherein said sales data for said one or more items in said particular time frame is collected in a substantially real-time manner.

5. The method as recited in claim 4, wherein said sales data for said one or more items in said particular time frame is collected by an on-line inventory.

6. The method as recited in claim 1, wherein said sales data for said one or more items in said particular time frame is collected in a batch manner.

7. The method as recited in claim 1, wherein said particular time frame is adjustable.

8. The method as recited in claim 1, wherein said sales data collected for said one or more items in said particular time frame and said estimated sales projections for said one or more items in said particular time frame are analyzed by a statistical analysis tool.

9. The method as recited in claim 8, wherein said statistical analysis tool is a Poisson distribution.

10. The method as recited in claim 1, wherein said sales data collected for said one or more items in said particular time frame and said estimated sales projections for said one or more items in said particular time frame are analyzed by an absolute comparison.

11. The method as recited in claim 1, wherein said interested party is notified regarding any items of said one or more items in said particular time frame that have performed unexpectedly versus said estimated sales projections by e-mail.

12. The method as recited in claim 1, wherein said interested party is notified regarding any items of said one or more items in said particular time frame that have performed unexpectedly versus said estimated sales projections by paging.

13. The method as recited in claim 1 further comprising the step of:
generating a report regarding any items of said one or more items in said particular time frame that have performed unexpectedly versus said estimated sales projections.

14. A computer program product having a computer readable medium having computer program logic recorded thereon for analyzing inventory information using time frames, comprising:
programming operable for determining estimated sales projections for one or more items in a particular time frame;
programming operable for collecting sales data for said one or more items in said particular time frame;
programming operable for analyzing sales data collected for said one or more items in said particular time frame with said estimated sales projections for said one or more items in said particular time frame; and
programming operable for notifying an interested party or a system regarding any items of said one or more items in said particular time frame that have performed unexpectedly versus said estimated sales projections.

15. The computer program product as recited in claim 14 further comprises:
programming operable for storing results of said analysis of said sales data collected for said one or more items in said particular time frame with said estimated sales projections for said one or more items in said particular time frame.

16. The computer program product as recited in claim 14, wherein said estimated sales projections in said particular time frame are derived from sales trends and sales projection data over a time duration that exceeds said particular time frame.

17. The computer program product as recited in claim 14, wherein said sales data for said one or more items in said particular time frame is collected in a substantially real-time manner.

18. The computer program product as recited in claim 17, wherein said sales data for said one or more items in said particular time frame is collected by an on-line inventory.

19. The computer program product as recited in claim 14, wherein said sales data for said one or more items in said particular time frame is collected in a batch manner.

20. The computer program product as recited in claim 14, wherein said particular time frame is adjustable.

21. The computer program product as recited in claim 14, wherein said sales data collected for said one or more items in said particular time frame and said estimated sales projections for said one or more items in said particular time frame are analyzed by a statistical analysis tool.

22. The computer program product as recited in claim 21, wherein said statistical analysis tool is a Poisson distribution.

23. The computer program product as recited in claim 14, wherein said sales data collected for said one or more items in said particular time frame and said estimated sales projections for said one or more items in said particular time frame are analyzed by an absolute comparison.

24. The computer program product as recited in claim 14, wherein said interested party is notified regarding any items of said one or more items in said particular time frame that have performed unexpectedly versus said estimated sales projections by e-mail.

25. The computer program product as recited in claim 14, wherein said interested party is notified regarding any items of said one or more items in said particular time frame that have performed unexpectedly versus said estimated sales projections by paging.

26. The computer program product as recited in claim 14 further comprises:
programming operable for generating a report regarding any items of said one or more items in said particular time frame that have performed unexpectedly versus said estimated sales projections.

27. A system, comprising:
one or more POS terminals;
a data processing system coupled to said one or more POS terminals, wherein said data processing system comprises:
a processor;
a memory unit operable for storing a computer program operable for analyzing inventory information using time frames;
an input mechanism;
an output mechanism;
a bus system coupling the processor to the memory unit, input mechanism, and output mechanism, wherein the computer program is operable for performing the following programming steps:
determining estimated sales projections for one or more items in a particular time frame;
receiving sales data for said one or more items in said particular time frame from said one or more POS terminals;
analyzing sales data received for said one or more items in said particular time frame with said estimated sales projections for said one or more items in said particular time frame; and
notifying an interested party or a system regarding any items of said one or more items in said particular time frame that have performed unexpectedly versus said estimated sales projections.

28. The system as recited in claim 27, wherein the computer program is further operable for performing the following programming step:
storing results of said analysis of said sales data received for said one or more items in said particular time frame with said estimated sales projections for said one or more items in said particular time frame.

29. The system as recited in claim 27, wherein said estimated sales projections in said particular time frame are derived from sales trends and sales projection data over a time duration that exceeds said particular time frame.

30. The system as recited in claim 27, wherein said sales data for said one or more items in said particular time frame is received in a substantially real-time manner.

31. The system as recited in claim 27, wherein said sales data for said one or more items in said particular time frame is collected by an on-line inventory in said one or more POS terminals, wherein said one or more POS terminals transmit said sales data for said one or more items in said particular time frame to said data processing system in a substantially real-time manner.

32. The system as recited in claim 27, wherein said sales data for said one or more items in said particular time frame is received in a batch manner.

33. The system as recited in claim 27, wherein said particular time frame is adjustable.

34. The system as recited in claim 27, wherein said sales data received for said one or more items in said particular time frame and said estimated sales projections for said one or more items in said particular time frame are analyzed by a statistical analysis tool.

35. The system as recited in claim 34, wherein said statistical analysis tool is a Poisson distribution.

36. The system as recited in claim 27, wherein said sales data received for said one or more items in said particular time frame and said estimated sales projections for said one or more items in said particular time frame are analyzed by an absolute comparison.

37. The system as recited in claim 27, wherein said interested party is notified regarding any items of said one or more items in said particular time frame that have performed unexpectedly versus said estimated sales projections by e-mail.

38. The system as recited in claim 27, wherein said interested party is notified regarding any items of said one or more items in said particular time frame that have performed unexpectedly versus said estimated sales projections by paging.

39. The system as recited in claim 27, wherein the computer program is further operable for performing the following programming step:
generating a report regarding any items of said one or more items in said particular time frame that have performed unexpectedly versus said estimated sales projections.
